(19) United States
(12) Patent Application Publication
(10) Pub. No.: US 2011/0284677 A1
(43) Pub. Date: Nov. 24, 2011

(54) TENSIONING LOCK

(75) Inventors: Ägyd Pengg, Klagenfurt (AT); Bernhard Nieß, Ottendorf (AT)

(73) Assignee: PEWAG SCHNEEKETTEN GMBH & CO KG, BRUCKL (AT)

(21) Appl. No.: 13/089,995

(22) Filed: Apr. 19, 2011

(30) Foreign Application Priority Data
May 19, 2010 (EP) 10450087.1

(51) Int. Cl. B60C 27/10; B65H 75/48

(52) U.S. Cl. 242/384.7

(57) ABSTRACT

A tensioning apparatus (60) for an anti-skid chain to be mounted on a vehicle wheel, a tensioning strand (7) which can be pulled into the housing is connected within the housing (61) to a winding roll (62) with a ratchet wheel (65), which winding roll is pretensioned in the winding direction and rotatable about its axis. A ratchet pawl (64) associated with the ratchet wheel can be moved to the outside under the influence of centrifugal force during wheel rotation, starting from a release position not in engagement with the ratchet wheel and the tensioning strand is not blocked, causing an engagement of the ratchet pawl in the ratchet wheel and a blocking of the tensioning strand against its tensioning direction. A magnetic holding element (68) cooperates with the ratchet pawl and counteracts deflection of the ratchet pawl from the release position during standstill or slow rotation of the wheel.

The invention relates to a tensioning apparatus for an anti-skid chain to be mounted on a wheel of a vehicle, comprising a housing and a tensioning strand that can be pulled into the housing through an opening in the housing, with the tensioning strand being connected within the housing to a winding roll which is pretensioned in the winding direction and is mounted to be rotatable about its axis, with a ratchet wheel with at least one ratchet pawl associated with the wheel being provided on the winding roll, and with the tensioning strand being blockable by engagement of the ratchet pawl in the ratchet wheel against its direction of tension. In this process, the ratchet pawl can assume a release position in which it is not in engagement with the ratchet wheel and the tensioning strand is not blocked and is movable at least in part to the outside under the influence of centrifugal force from this release position under rotation of the wheel, so that an engagement of the ratchet pawl in the ratchet wheel is effected.

Tensioning apparatuses are used in anti-skid chains in order to avoid an undesirable return of the tensioning strand against the tensioning direction. One possible arrangement of the tensioning lock on the anti-skid chain or the tensioning strand is known from AT 412 202 B for example.

A tensioning apparatus of the kind mentioned above has been disclosed in EP 2 151 336 A1. The ratchet pawl represents a centrifugal pendulum which is brought into engagement with the ratchet wheel under the influence of centrifugal force from a specific rotational speed of the vehicle wheel and returns to its original position after standstill of the wheel or a reduction of the rotational speed of the wheel. As a result, an engagement of the ratchet pawl in the ratchet wheel occurs from a specific rotational speed of the wheel or speed of the vehicle and thus a fixing of the tensioning strand against its winding-up direction. On the one hand, this allows blocking the tensioning strand irrespective of manual actuation by the person who handles the chain during mounting and dismounting. On the other hand, inadvertent unwinding of the tensioning strand from the winding roll can be prevented and secure holding of the anti-skid chain on the tire can be achieved, without leading to any impairment or obstruction in handling the chain (when the wheel is idle).

The return of the ratchet pawl to the release position occurs in the tensioning apparatus of EP 2 151 336 A1 either passively or by a spring. The former means that a return will only occur when the tensioning apparatus assumes a suitable orientation. No reliable returning is thus provided. Although returning with a spring offers reliable returning in all positions of the tensioning apparatus, the spring force reduces the pressing force of the ratchet pawl on the ratchet wheel.

It is the object of the invention to provide a tensioning lock of the kind mentioned above which does not need to be actuated manually for release on the one hand and the return of the ratchet pawl is improved on the other hand. In addition, it should have a sturdy and simple configuration which meets the requirements of rough operation.

On the basis of a tensioning lock of the kind mentioned above, this object is achieved with the help of a magnetically acting holding element which can cooperate with the ratchet pawl via magnetic interaction and produces a return force at least in the release position of the ratchet pawl which counteracts a deflection of the ratchet pawl from the release position.

This solution provides a simple and reliable returning of the ratchet pawl by a “magnetic spring” during standstill or slow rotation of the wheel. According to the nature of magnetic interaction, the force which the magnetic holding element exerts on the ratchet pawl does not increase with growing distance, but rather decreases. This leads to a lighter dimensioning of the components of the tensioning lock. Moreover, a better fixing effect of the ratchet pawl on the ratchet wheel is obtained in the blocking position in comparison with conventional embodiments with a coil spring (or other elastic springs), especially when the arrangement is chosen in such a way that the return force drops to zero or a very low value in the blocking position.

In an advantageous further development of the invention, the holding element is realized in form of a permanent magnet attached to the housing, and the ratchet pawl, or at least a part of the same, comprises magnetizable material which moves away from the holding element upon deflection of the ratchet pawl from the release position. It is especially advantageous when the ratchet pawl consists of a magnetizable material, especially a soft-magnetizable or hard-magnetizable material.

In one embodiment of the invention, e.g. in combination with a gearing on an inner circumferential surface of the ratchet wheel, the ratchet pawl can be movably mounted along a guide held in the housing. In this case, the guide can permit a movement of the ratchet pawl along a curved path, at the one end of which the ratchet pawl will engage into the ratchet wheel with projections provided on the pawl.

Another embodiment of the invention which is characterized by a simple and thus cost-effective configuration provides that the ratchet pawl is rotatably mounted in an eccentric manner about an axis. In this case, a free end section which does not cooperate with the ratchet wheel can be longer and have more mass than a second end section of the ratchet pawl which cooperates with the ratchet wheel.

Moreover, the ratchet wheel can advantageously comprise a gearing on an outer circumferential surface, by means of which a further simplification of the configuration can be achieved.

A highly compact configuration can be achieved in such a way that the ratchet wheel has a gearing on an inner circumferential surface, with which the ratchet pawl can be brought into engagement by a displacement and/or twisting caused by centrifugal force. In this configuration, the ratchet pawl is enclosed by the ratchet wheel either in its entirety or at least with respect to a portion cooperating with the ratchet wheel.

In a further development of the invention, a simple and compact configuration can be achieved in that the ratchet pawl is mounted to be displaceable in the radial direction on a guide pin of the housing, with the ratchet pawl having a receiver for the guide pin, with the end section of the ratchet pawl which is adjacent to the receiver and which can be brought into engagement with the ratchet wheel having the largest part of the mass of the ratchet pawl. In this case, a magnetic spring can be provided by means of a holding element which is arranged between the guide pin and an end region of the recess comprising the projection which can be brought into engagement with the ratchet wheel. This can be realized by means of a permanent magnet element for example. Furthermore, the ratchet pawl can be rotatably held about an axis in the region of its end section cooperating with the ratchet wheel in order to ensure good guidance and definition of this sequence of movements of the ratchet pawl and thus good functionality. The ratchet pawl can comprise a recess for receiving the aforementioned guide pin of the housing. A free end section of the ratchet pawl which is adjacent to the recess and is opposite of the end region cooperating with the ratchet wheel can have the largest part of the mass of the ratchet pawl.

A flat configuration of the tensioning lock is achieved in such a way that the ratchet pawl is arranged in the manner of a plate and comprises at least one projection which can be brought into engagement with the ratchet wheel.

A simplified assembly and a compact configuration of the tensioning lock can be achieved in such a way that the winding roll and the ratchet wheel are integrally arranged with one another. The winding roll and the ratchet wheel can also be separate components which are connected with one another in the production of the tensioning lock.

The invention plus further advantages will be explained below in closer detail by reference to non-limiting embodiments which are schematically shown in the drawings, wherein:

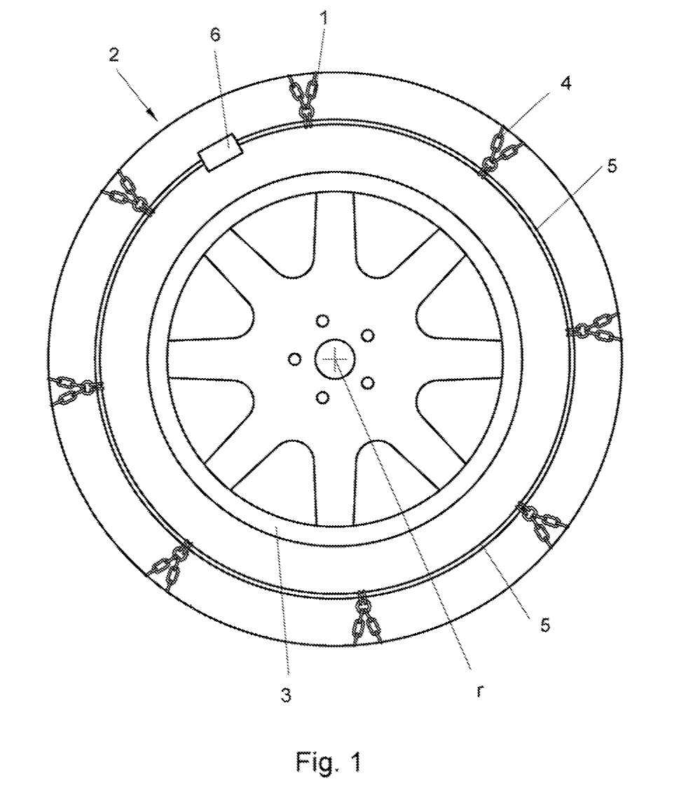

FIG. 1 shows an anti-skid chain with a tensioning lock for its one side strand, mounted on a vehicle tire, in a side view;

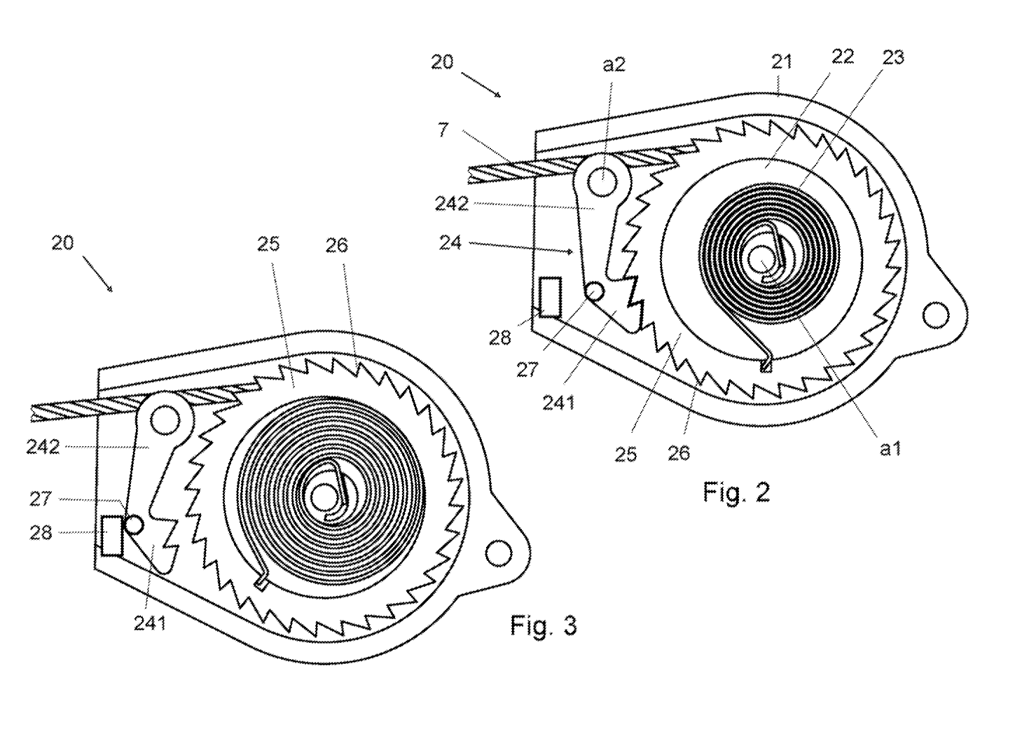

FIG. 2 shows a tensioning lock according to a first embodiment of the invention with removed housing cover, with the ratchet pawl being in a blocking position;

FIG. 3 shows the tensioning lock of FIG. 2, with the ratchet pawl being in a release position;

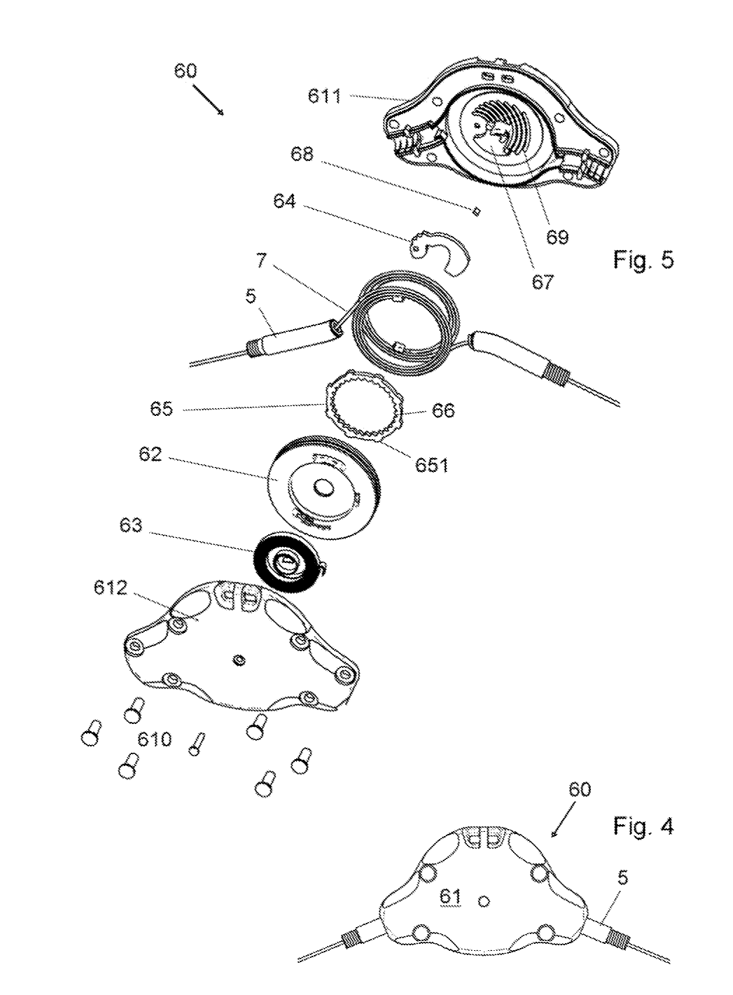

FIG. 4 shows a side view of a tensioning lock according to a further embodiment of the invention;

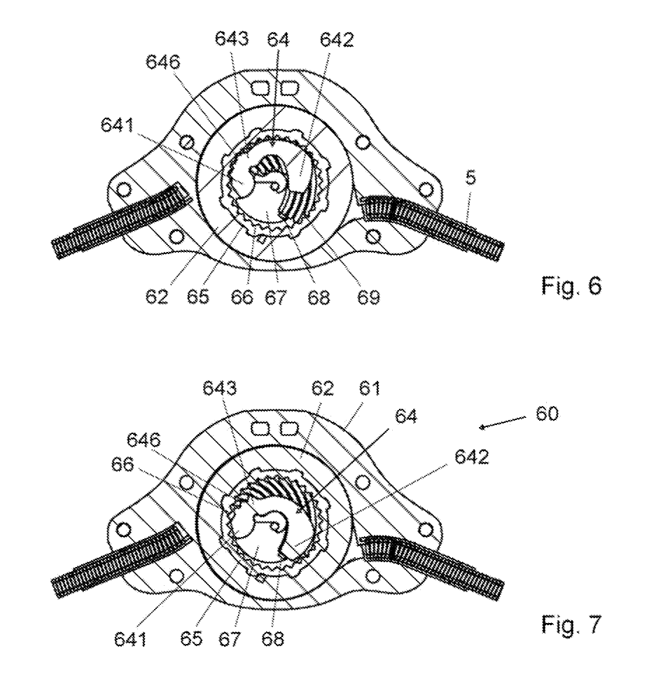

FIG. 5 shows the tensioning lock of FIG. 6 in an exploded view;

FIG. 6 shows a sectional view of the tensioning lock of FIG. 6, with the ratchet pawl being in a blocking position, and

FIG. 7 shows a sectional view of the tensioning lock of FIG. 6, with the ratchet pawl being in a release position.

FIG. 1 shows an anti-skid chain 1 in a side view which has been mounted on a tire 2 of a vehicle wheel 3 with the wheel axis r. The chain net 4 of the anti-skid chain 1 is held together or tensioned on the inside and outside of the tire or tires in the known manner by side strands 5. A tensioning lock 6 blocks the tensioning strand against the tensioning direction during a rotational movement of the wheel.

Notice must be taken that the side strands 5 on the inside of the tire can be arranged elastically and can be held together by a tensioning lock 6 according to the invention. Another construction can be used on the outside however. On the other hand, the entire tensioning device including the tensioning lock can also be arranged in a similar way on the outside and the inside. In any case, the invention is not limited in its application to any one of the two sides of the tire.

The side strand 5 can comprise a tensioning. spring, e.g. a coil spring. A tensioning strand, which will be designated below with a reference numeral 7, can extend in the interior of the coil spring. The tension of the tensioning spring which represents the jacket is so large that the anti-skid chain 1, which is a snow chain for example, is tensioned after applying the chain.

FIGS. 2 to 7 show embodiments 20, 60 of the tensioning lock 6 in accordance with the invention. It is understood that the invention is not limited to the illustrated embodiments. Instead, combinations of the embodiments and modifications to the same are possible to the extent as they fall within the scope of claims.

In accordance with FIG. 2, the tensioning lock 20 of a first embodiment comprises a housing 21. The tensioning strand 7 can be pulled into the housing 21 through an opening in the housing or it can be pulled out of the housing 21. through said opening. Within the housing 21, the tensioning strand 7 is connected to a winding roll 22 which is pretensioned in the winding-up direction and is rotatably held about it axis a1, on which the tensioning strand 7 can be wound up. The winding roll 22 can be pretensioned in the winding-up direction by means of a coil spring 23 for example, the ends of which are fixed on the winding roll 22 and the housing 21 of the tensioning lock 20. The other end of the tensioning strand 7 can be fastened on the outside to the housing 21 of the tensioning lock 20.

A ratchet wheel 25 with at least one ratchet pawl 24 associated with the wheel is provided on the winding roll 22. The ratchet wheel 25 comprises a gearing 26 on an outside circumferential surface. The ratchet pawl is mounted to be eccentric about an axis a2 and is pivotable about said axis a2 which is arranged as a journal. As is shown in the illustrations of FIGS. 2 and 3, the bearing of the ratchet pawl can occur with its end region 242 which is opposite of the end 241 cooperating with the ratchet wheel 25.

In FIG. 2, the ratchet pawl is moved up to the ratchet wheel 25 and the tensioning strand 7 can be blocked against its tensioning direction by the resulting engagement of the ratchet pawl 24 in the ratchet wheel 25.

FIG. 3 shows the ratchet pawl 24 during standstill of wheel 3. In this case, the ratchet pawl 24 is in an idle position (release position), in which it is not in engagement with the ratchet wheel 25, the tensioning strand 7 is not blocked and can be pulled out of the housing under the action of a force against its winding-up direction, and the anti-skid chain 1 can be mounted or dismounted on the tire 2. The tensioning lock 20 is used for the purpose of fixing the tensioning strand 7 even under the influence of considerable forces in operation and thus to ensure a good grip of the anti-skid chain 1.

It applies to all illustrated embodiments of the invention that the ratchet pawl and the gearing of the ratchet wheel can be arranged in a congruent manner with respect to each other. The winding roll 22 and the ratchet wheel 25 can be advantageously integrally arranged with one another in all embodiments of the invention.

It also applies to all illustrated embodiments of the invention that under the action of the centrifugal force produced by a rotation of the wheel 3 the ratchet pawl 24 is moved at least in part to the outside from an idle position during the standstill of the wheel 3, in which it is not in engagement with the ratchet wheel 25 and the tensioning strand 7 is not blocked. As a result of this movement which is caused by the centrifugal force, an engagement of the ratchet pawl 24 in the ratchet wheel 25 is produced. The return of the ratchet pawl from the blocking position to the idle position occurs with the help of a magnetic holding element which can be disposed in the housing or on the ratchet wheel itself, e.g. instead of the counterpart 27.

A permanent magnet 28 which is fixed in the housing is associated with the ratchet pawl 24 and acts on a counterpart 27 which consists of a magnetic material, whereas the remainder of the ratchet pawl consists of a non-magnetic material. The permanent magnet 28 which is used as a holding element therefore exerts a magnetic force on the counterpart 27. The holding element 28 can be arranged for example in form of a permanent magnet made of neodymium, iron and boron (“NdFeB”, more precisely an alloy based on the base compound of Nd₂Fe₁₄B). NdFeB magnets which are nickel-plated for protection from corrosion are well-known and are available on the market. They are characterized by a high magnetic field density and high coercive field strengths. The counterpart 27 in the ratchet pawl typically consists of stainless steel. Generally, the counterpart can consist of iron, magnetizable steel, or any other easily magnetizable soft-magnetic or hard-magnetic material. The choice of the materials is made with respect to the fact that the resulting attractive force between magnet and counterpart can be overcome by the centrifugal force which is obtained during a not too high rolling speed of the wheel (e.g. corresponding to 1.0 km/h driving speed for example). The other components of the tensioning lock appropriately consist of non-magnetic materials such as high-strength plastics, aluminum or non-magnetic steel.

In one variant, the entire ratchet pawl 24, or its end 241 cooperating with the ratchet wheel, can also consist of magnetic material, so that the ratchet pawl performs the function of the counterpart itself. In another variant, the positions of magnet and counterpart can also be mutually exchanged, so that the magnet is arranged on the ratchet pawl and operates with a component or a part of the housing which is used as the counterpart.

Once the rotational movement of the wheel decreases, the effect of the centrifugal force also decreases accordingly. Thereafter, the magnetic attraction between the holding element and the counterpart gains the upper hand and the ratchet pawl falls back into the release position (FIG. 3).

FIGS. 4 to 7 show a further embodiment of the invention, in which the tensioning lock 60 comprises a ratchet pawl 64, the movement of which is determined by a guide instead of an axial bearing.

In this embodiment, the housing 61 (FIG. 4) consists of two parts, which are the base part 611 and the cover 612 of the housing which. are connected by rivet 610 for example (FIG. 5). The tensioning lock 60 preferably rests with the rear of the base part 611. on the tire in the mounted state of the chain 1. As is shown in FIG. 5, the two ends of the tensioning strand 7 are wound up on the winding roll 62. The winding of the two ends of the strand leads to the advantage of a symmetric shortening of the tensioning strand. As in the other embodiments, the winding roll 62 is pretensioned by means of a coil spring 63. The ratchet wheel 65 is a component that is separate from the winding roll 62 in this embodiment, which is in contact on the outside of the ratchet wheel via nubs 651 with the winding roll 62 and is provided with an internal gearing 66. The asymmetric arrangement of the nubs 651 offers advantages in production and further provides improved connection between ratchet wheel and winding roll.

The ratchet pawl 64 is not held in this arrangement in a journal. The movement of the ratchet pawl is rather defined by a guide. A guide element 67 is provided in the housing for this purpose which is immovable in relation to the housing, and is preferably arranged integrally with the base part 611 of the housing and on the floor of the housing in the interior of the same. The ratchet pawl 64 has a shape which forms a recess which encloses the guide element, with the ratchet pawl sliding along the flanks of the guide element and being able to rest on the guide element 67 transversely to this movement. As is shown in FIGS. 6 and 7, the ratchet pawl 64 especially comprises two oppositely disposed and regions 641, 642, between which the guide element is situated, and which are connected by a central regions 643 guided around the guide element. The two end regions 641, 642 rest with one flank each on the guide element 67. As is shown, the flanks can be bent, typically in form of concentric rotational areas, e.g. cylinder jacket areas, so that they define a curved path of the ratchet pawl 64.

The two end regions 641, 642 of the ratchet pawl 64 are provided with a differently large configuration and the outer end region 642 has the main (i.e. largest) part of the mass of the ratchet pawl. The ratchet 64 is shaped in total in such a way that it is disposed further to the outside in relation to the guide element 67. (The term “outside” shall be understood in this respect with reference to an axis r of a wheel, on which the chain 1 and tensioning lock have been mounted.) During a rotational movement of the wheel, the ratchet pawl 64 is moved under the influence of centrifugal force to the outside, i.e. to the top in FIG. 6. In this case, the ratchet pawl 64 comes into engagement with the gearing 66 via projections 646 arranged in the central region 643 and thus causes a blocking of the ratchet wheel 65 and the cooperating winding roll 63. As a result of the already mentioned curved guidance, the part of the gearing 66 which cooperates with the projections 646 of the ratchet pawl 64 is loaded by shearing to a considerably lower extent. The forces occurring during the blocking of the ratchet wheel 65 will be absorbed by the guide element 67 which is used as support.

In order to achieve a reliable return of the ratchet pawl 64 to the release position as shown in FIG. 7 when the wheel comes to a standstill, a magnetically acting holding element 68 is provided in the floor of the housing formed in the base part 611 of the housing, which holding element is realized in the illustrated example as a permanent magnet. In the illustrated embodiment, a magnetic element of the size 3×2×1 mm made of nickel-plated NdFeB is used for example. The ratchet pawl consists of stainless steel. The other components of the tensioning lock consist of non-magnetic materials such as high-strength plastics, aluminum or non-magnetic steel.

The holding element is disposed at a location in the floor of the housing which lies close to the end region 642 of the ratchet pawl 64 when it is in the release position. During a deflection of the ratchet pawl it moves away from the holding element. The holding element 68 acts magnetically on the end region 642 and attracts the same with a magnetic force, so that in the release position the ratchet pawl is held with a magnetic force. When the wheel rotates on which the chain is mounted with the tensioning lock 60, a centrifugal force additionally acts on the ratchet pawl 64 as already mentioned, the magnitude of which increases with the square of the rotational speed (and thus the square of the travelling speed). The centrifugal force can therefore overcome the magnetic force from a certain speed, so that the ratchet pawl 24 is moved to the blocking position as shown in FIG. 6.

The ratchet pawl is so far away from the magnet 68 in the blocking position that the magnetic force is negligibly low as a result of the limited sphere of action of the magnetic field. This leads to a reliable blocking of the winding roll, without this being counteracted by a returning force (e.g. a return spring in conventional models). When the vehicle becomes slower and finally comes to a standstill, the tensioning lock will assume an orientation as shown in FIG. 6 at least temporarily during very slow travel, in which the ratchet pawl is disposed above the magnetic holding element 68. The ratchet pawl 64 then falls downwardly under the influence of gravity towards the holding element, by means of which it moves into the sphere of action of the holding element and is held in the release position of FIG. 7. This leads to a reliable return of the ratchet pawl to the idle position of the release position which is kept in this position during standstill of the wheel.

As is further shown in FIG. 5, the ratchet pawl is arranged in a plate-like manner and lies with its flat sides on the winding roll 62 on the one hand and on the inside of the base part of the housing on the other hand, which is the floor of the housing. In order to improve mobility of the ratchet pawl 64, the housing floor can be provided with ribs 69 which reduce the effective bearing surface and thus promote sliding of the ratchet pawl 64 during its movement along the guide element 67. If desired, the ribs 69 can be formed in such a way that they additionally contribute to the guidance of the movement of the ratchet pawl 64.

It is understood that the illustrated invention is not limited to the illustrated embodiments, but that it comprises all embodiments which fall under the independent claim. In particular, the illustrated embodiments can be combined with one another, wherever appropriate. In particular, a ratchet pawl can also be guided with the help of a pin formed out of the same as an axis in a variant in connection with the embodiment of FIG. 5, or conversely the other embodiment with the help of a guide instead of an axis. Similarly, the positions of magnet and counterpart can be exchanged.

We claim:

1. A tensioning lock (20, 60) for an anti-skid chain to be mounted on a wheel (3) of a vehicle, comprising a housing (21, 61) and a tensioning strand (7) that can be pulled into the housing through an opening in the housing, with the tensioning strand being connected within the housing (21, 61) to a winding roll (22, 62) which is pretensioned in the winding direction and is mounted to be rotatable about its axis (a1), with a ratchet wheel (25, 65) with at least one ratchet pawl (24, 64) associated with the wheel being provided on the winding roll, and with the tensioning strand (7) being blockable by engagement of the ratchet pawl (24, 64) in the ratchet wheel (25, 65) against its direction of tension, with the ratchet pawl (24, 64), from a release position in which it is not in engagement with the ratchet wheel (25, 65) and the tensioning strand (7) is not blocked, being movable at least in part to the outside under the influence of centrifugal force under rotation of the wheel (7), with such movement effecting an engagement of the ratchet pawl (24, 64) in the ratchet wheel (25, 65),
characterized by
a magnetic holding element (28, 68) which cooperates with the ratchet pawl via magnetic interaction and generates a return force at least in the release position of the ratchet pawl (24, 64) which counteracts a deflection of the ratchet pawl from the release position.

2. A tensioning lock according to claim 1, characterized in that the holding element (28, 68) is realized by a permanent magnet attached in the housing and the ratchet pawl (24, 64) comprises at least partly magnetizable material which moves away from the holding element during deflection of the ratchet pawl from the release position.

3. A tensioning lock according to claim 2, characterized in that the ratchet pawl (64) consists of a magnetizable material, especially a soft-magnetic or hard-magnetic material.

4. A tensioning lock according to claim 1, characterized in that the ratchet pawl (64) is movably held along a guide (67) which is held in the housing.

5. A tensioning lock according to claim 4, characterized in that the guide (67) permits a movement of the ratchet pawl (64) along a curved path, at the one of which the ratchet pawl (64) engages in the ratchet wheel (65) by means of at least one projection (646).

6. A tensioning lock according to claim 1, characterized in that the ratchet pawl (24) is held to be eccentrically rotatable about an axis (a2).

7. A tensioning lock according to claim 1, characterized in that the ratchet pawl (64) is arranged at least partly within the ratchet wheel (65) and the ratchet wheel (65) has a gearing (56) on an inner circumferential surface, with which the ratchet pawl (64) can be brought into engagement by a deflection of the ratchet pawl as effected by centrifugal force.

8. A tensioning lock according to claim 1, characterized in that the ratchet wheel (25) comprises a gearing (26) on an outer circumferential surface, with which the ratchet wheel cooperates in the blocking position.

9. A tensioning lock according to claim 1, characterized in that the ratchet pawl (64) is arranged in the manner of a plate and comprises at least one projection (646) which can be brought into engagement with the ratchet wheel (65).

10. A tensioning lock according claim 1, characterized in that the winding roll (22) and the ratchet wheel (25) are arranged integrally with each other.
